(19) United States
(12) Patent Application Publication
(10) Pub. No.: US 2005/0191523 A1
(43) Pub. Date: Sep. 1, 2005

(54) Conjugated polymer doped nanocomposite silica thin films

(76) Inventors: Andrew M. Dattelbaum, Los Alamos, NM (US); Andrew P. Shreve, Santa Fe, NM (US); Hsing-Lin Wang, Los Alamos, NM (US)

Correspondence Address: UNIVERSITY OF CALIFORNIA;LOS ALAMOS NATIONAL LABORATORY, P.O. BOX 1663, MS A187, LOS ALAMOS, NM, 87545, US

(21) Appl. No.: 10/789,588

(22) Filed: Feb. 27, 2004

(51) Int. Cl. B32B 9/04

(52) U.S. Cl. 428/704

(57) ABSTRACT

The present invention discloses a composite structure including an inorganic thin film having a defined mesostructure formed in a surfactant based formation process including a non-cationic surfactant template material, and, a conjugated polymer immobilized within the mesostructured inorganic thin film. A sensor using such a composite structure as a responsive element and a method of detecting trace amounts of nitro-containing organic species are also disclosed.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates to conjugated polymer-doped nanocomposite thin films and in particular to conjugated polymer-doped nanocomposite silica thin films. Further, the present invention relates to chemical sensing of vapor-phase nitroaromatic compounds by use of such conjugated polymer-doped nanocomposite thin films.

### BACKGROUND OF THE INVENTION

Functionalization of nanocomposite films has recently received considerable attention in the preparation of new optically active materials. Incorporation of luminescent species into nanocomposite films not only provides a rigid, protective environment for the encapsulated materials, but can also have a significant effect on the resulting optical properties.

Conjugated polymers, such as poly phenylene vinylene (PPV) and its derivatives, have become attractive candidates for use in numerous applications, including chemical and biological sensors, LEDs, and solar cells, because of their unique optical and electronic properties. Thus, the ability to control and manipulate the optical properties of conjugated polymers can have tremendous impact on a variety of technologies. Controlling the optical properties of poly(2,5-methoxy-propyloxy sulfonate phenylene vinylene) (MPS-PPV) can lead new useful sensing architectures. Recently, Chen et al., J. Amer. Chem. Soc., v. 122, pp. 9302-9303 (2000), have shown that addition of surfactants can be used to tune the optical properties of MPS-PPV, a water-soluble derivative of PPV, in aqueous solution for sensing applications. However, there is growing interest in organizing conjugated polymers as thin films for development of devices. For example, Chen et al., Chem. Phys. Lett., v. 330, pp. 27-33 (2000), describe the preparation of MPS-PPV thin films coated with a surfactant monolayer that yield highly luminescent films useful in reversible sensing of vapor-phase nitroaromatic compounds, which form as trinitrotoluene (TNT) breaks down.

Another approach using similar components has been encapsulation of polymer complexes such as MPS-PPV in an inert matrix formed by the templated growth of inorganic silica around an ordered cationic surfactant such as CTAB (see Hernandez et al., J. Amer. Chem. Soc., v. 123, pp. 1248-1249 (2001).

### SUMMARY OF THE INVENTION

To achieve the foregoing and other objects, and in accordance with the purposes of the present invention, as embodied and broadly described herein, the present invention provides a composite structure including an inorganic thin film having a defined mesostructure formed in a surfactant based formation process including a non-cationic surfactant template material, and, a conjugated polymer immobilized within the mesostructured inorganic thin.

In one embodiment, the present invention provides a sensor including a responsive element for a detectable species, said responsive element including a nanocomposite structure of an inorganic thin film having a defined mesostructure and a conjugated polymer immobilized within the mesostructured inorganic thin film, and, a detector means for detecting a response of the responsive element upon exposure to the detectable species.

The present invention further provides a method of detecting trace amounts of nitro-containing organic species within an environment including placing a selected chemical sensor into an environment, the sensor including a responsive element for the detectable nitro-containing organic species, the responsive element including a nanocomposite structure of an inorganic thin film having a defined mesostructure and a conjugated polymer immobilized within the mesostructured inorganic thin film, the sensor element adapted for a chemical interaction of a nitro-containing organic species therewith, for a sufficient time wherein nitro-containing organic species can have a chemical interaction with the responsive element, measuring a change resulting from the chemical interaction of nitro-containing organic species with the responsive element, and, correlating the measured change with a quantitative or qualitative output relating to the nitro-containing organic species.

### BRIEF DESCRIPTION OF THE DRAWINGS

FIG. 1 shows X-ray powder diffraction (XRD) patterns from MPS-PPV doped mesostructured nanocomposite silica thin films prepared using: (a) CTAB; (b) Pluronics123: and (c) Brij56 as the templating surfactant.

FIG. 2 shows emission of MPS-PPV doped mesostructured nanocomposite silica thin films using: (a) CTAB; (b) Pluronics123; and, (c) Brij56 as the templating surfactant. The inset of FIG. 2 shows UV-Vis absorption for: (d) MPS-PPV doped in a sol-gel film; (e) MPS-PPV doped mesostructured nanocomposite silica thin films using Brij56; and, (f) MPS-PPV doped mesostructured nanocomposite silica thin films using CTAB.

FIG. 3(i) shows emission of MPS-PPV in an ethanolic solution and FIG. 3 (ii) shows emission in a mesostructured silica thin film; each excited at: (a) 350 nm; (b) 400 nm; (c) 450 nm; and (d) 500 nm.

FIG. 4 shows emission of MPS-PPV doped mesostructured nanocomposite silica thin films formed using CTAB, Pluronics123 or Brij56 as the templating surfactant where such films were exposed to dinitrotoluene vapor for 24 hours followed by exposure to vacuum for 24 hours.

### DETAILED DESCRIPTION

The present invention is concerned with preparation of conjugated polymer-doped nanocomposite thin films, e.g., nanocomposite silica thin films, which can be repeatedly used for chemsensing of vapor-phase nitroaromatic compounds. The doping level and luminescence properties of an immobilized conjugated polymer, such as poly(2,5-methoxy-propyloxy sulfonate phenylene vinylene) (MPS-PPV), can be modified by changing the surfactant species used to template the mesostructure of the nanocomposite film. Such a conjugated polymer-doped nanocomposite film can be repeatedly used for chemsensing of vapor-phase 2,4-dinitrotoluene (DNT), which is a compound found in landmines and other unexploded ordinance.

The term “mesostructure” refers to articles having ordered channels or other structural features with dimensions in the range of 1 nm to 50 nm that are filled with at least an organic surfactant, and optionally with another material such as a polymer dispersed throughout the organic surfactant. Mesoporous materials can be derived from mesostructured materials by removal of the surfactant leaving behind an empty channel, called a pore. In general, the shape of ordered channels in a mesostructured material may vary. In some embodiments, ordered channels in mesostructured materials are randomly shaped. Materials having either a mesostructure or mesoporous structure can be in different forms such as spherical, thin film, block, and fiber.

Mesostructured materials can be generally prepared in two basic steps: (i) a suitable template is obtained or prepared; and (ii) the template is permeated with a precursor, which deposits a reaction product (or deposit) within the template. In some embodiments, the template is removed, leaving behind the mesoporous material.

The surfactant of the present invention may be a cationic surfactant, a nonionic surfactant or an anionic surfactant. Other surfactants that may be used in the present invention include amphiphilic block copolymers, such as Pluronic copolymers. Such Pluronics copolymers (and similarly Poloxamers copolymers) are synthetic block copolymers of ethylene oxide and propylene oxide having the general structure: OH(OCH₂CH₂)ₐ(OCH₂CH₂CH₂)_{b}(OCH₂CH₂)ₐH. The following variants based on the values of a and b are commercially available from BASF+ Performance Chemicals (Parsippany, N.J.) under the trade name Pluronic and which consist of the group of surfactants designated by the CTFA name of Poloxamer 108, 188, 217, 237, 238, 288, 338, 407, 101, 105, 122, 123, 124, 181, 182, 183, 184, 212, 231, 282, 331, 401, 402, 185, 215, 234, 235, 284, 333, 334, 335, and 403. For the most commonly used poloxamers 124, 188, 237, 338 and 407 the values of a and b are 12/20, 79/28, 64/37, 141/44 and 101/56, respectively. Anionic surfactants that can be used include, e.g., sulfates, sulfonates, phosphates, carboxylic acids and the like. Cationic surfactants that can be used include, e.g., alkylammonium salts, gemini surfactants, cetylethylpiperidinium salts, dialkyldimethylammonium and the like. One preferred cationic surfactant is cetyltrimethyl ammonium bromide (CTAB). Nonionic surfactants that can be used, with the hydrophilic group not charged, include, e.g., primary amines, poly(oxyethylene) oxides, octaethylene glycol monodecyl ether, octaethylene glycol monohexadecyl ether and the like. One preferred nonionic surfactant is Brij-56 (polyoxyethylene cetylether). The use of different surfactants can yield variations in both size and charge of the template.

Any suitable organosilane compound having the general formula R′ₓSi(OR)₄₋ₓ wherein R is a lower alkyl such as methyl, ethyl, propyl and the like, R′ is a non-hydrolyzable organic functional ligand and x is a or 2, can be used in forming the inorganic thin film. Suitable specific compounds within that formula include tetraethylorthosilicate (TEOS), tetramethylorthosilicate (TMOS) and tetrapropylorthosilicate (TPOS). In addition to silica, the inorganic thin film may be formed on titania, zirconia, alumina, tantalum oxide, tin oxide, hafnium oxide, and the like. Processes for forming inorganic thin films having a mesostructure are well know to those skilled in the art. One suitable process is described by Lu et al., Nature, v. 410, pp. 913-917 (2001).

The conjugated polymers can be chosen from trans-polyacetylenes, polypyrroles, polythiophenes, polyanilines, polyacetylenes, polythiophenes, poly(p-phenylene)s, poly(p-phenylene vinylene)s, polyfluorenes, polyaromatic amines and poly(thienylene-vinylene)s. Soluble derivatives thereof may also be selected as the conjugated polymer. The conjugated polymers can be a luminescent polymer or can be a conductive polymer such that there is an alterable property upon interaction with selected species when used as a sensor element. Water-soluble conjugated polymers such as MPS-PPV can be especially preferred. Other conjugated polymers such as poly(2-methoxy 5-(2′-ethyloxy-hexyloxy)p-phenylenevinylene (MEH-PPV) and poly(3-hexylthiophene) (P3HT) may be used as well.

In one aspect of the present invention, a sensor is presented. Such a sensor can include a responsive element for a detectable species, where the responsive element includes a nanocomposite structure of an inorganic thin film having a defined mesostructure and a conjugated polymer immobilized within the mesostructured inorganic thin film, and, a detector means for detecting a response of said responsive element upon exposure to said detectable species. In a preferred embodiment, the responsive element is reversibly responsive to the detectable species.

The detectable species can generally be a nitro-containing organic species such as, e.g., nitrobenzene (NB), dinitrobenzene (DNB), trinitrobenzene (TNB), hexanitrobenzene (HNB), nitrotoluene (NT), dinitrotoluene (DNT), and the like or detection of decomposition products of such nitro-containing organic species. In some instances, the detected nitro-containing organic species can serve as a signature compound for another particular explosive material, e.g., nitrotoluene, dinitrotoluene or trinitrobenzene can serve as a signature compound for trinitrotoluene (TNT), a material having a low volatility.

The present invention is more particularly described in the following example, which is intended as illustrative only, since numerous modifications and variations will be apparent to those skilled in the art.

### EXAMPLE 1

Surfactant/silicate nanocomposite thin films were prepared following a modified two-step process. A silica solution was prepared by refluxing a mixture of tetraethylorthosilicate (TEOS, 61 ml, from Aldrich Chem. Co.), anhydrous ethanol (61 ml, from Fisher Chem. Co.), >18MΩ deionized water (0.44 ml) and 0.07 N hydrochloric acid (HCl, 0.2 ml) at 60° C. for 90 minutes. Upon cooling to room temperature, a 10 ml aliquot of the above solution was diluted with ethanol (anhydrous, 20 ml) and hydrochloric acid (1 ml, 0.07N). An aqueous solution of a polymer, in this case, poly(2,5-methoxy-propyloxy sulfonate phenylene vinylene) (MPS-PPV) (0.35 ml of 1.8 g MPS-PPV dissolved in 120 ml of deionized water) was then added to the ethanolic solution. The MPS-PPV was prepared as previously reported by Chen et al., J. Amer. Chem. Soc., v. 122, pp. 9302-9303 (2000). Various surfactant species, including cetyl trimethylammonium bromide, C₁₆H₃₃(CH₃)₃Br (CTAB), Brij56 (C₁₆H₃₃(OCH₂CH₂O)ₙOH, where n is about 10, from Aldrich Chem. Co.) or Pluronics123, a block co-polymer (HO(CH₂CH₂O)₂₀(CH₂CH₂(CH₂)O)₇₀(CH₂CH₂O)₂₀OH), from BASF) were then added to the ethanolic silicate solution to yield the final mole ratios of 1 TEOS:22.2 EtOH:5.03 H₂O:0.004 HCL:2.8×10⁻⁴ MPS-PPV:0.002-0.045 surfactant. Polymer-doped nanocomposite thin films were then deposited onto acid-cleaned fused silica (from Almaz Optics, Inc.) by withdrawing the substrate vertically from the surfactant/silicate solutions at 10 to 20 centimeters per minute (cm/min). The nanocomposite films were dried in air for 48 hours prior to collecting XRD or florescence data.

XRD data was recorded on a Scintag XDS 2000 diffractometer CuKα radiation (λ=1.5406 A) with a Peltier detector that eliminates white radiation and beta lines in 2θ-θ (2θ=1-5°) scan mode using a step size of 0.02° per minute. Fluorescence measurements were collected on a Jobin-Yvonne Fluorolog instrument. Samples were positioned in a thin film sample holder at near grazing incidence such that the excitation beam illuminated the edge of the sample, which placed the film face directly in front of the detector. Unless noted otherwise, all films were characterized and exposed to dinitrotoluene within two weeks of preparation.

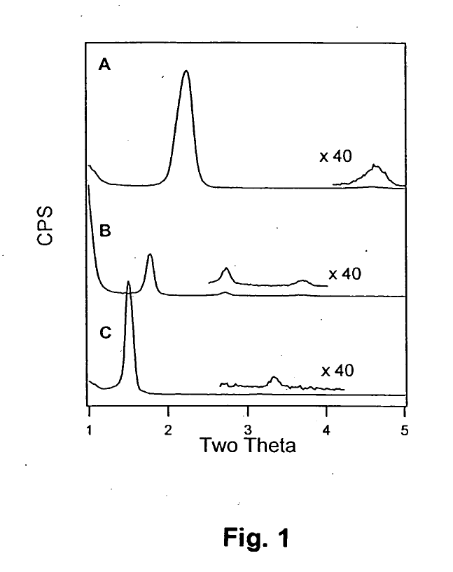

The mesostructure of polymer-doped nanocomposite thin films derived in this manner were verified using X-ray diffraction (XRD) as shown in FIG. 1. Mesoscopic ordering was readily observed in all MPS-PPV-doped films, regardless of surfactant used, without significant disruption or expansion of the surfactant microphase compared to nanocomposite films without the incorporated polymer. It should be noted that the polymer was only a small fraction of the organic material in the surfactant/silicate solution from which the nanocomposite films were withdrawn, i.e., only 0.24, 0.38 and 3.4 mole percent of the organic phase including the CTAB, Brij56 and Pluronics123, respectively. As such, the polymer was only a small fraction of the organic material in the film. Specifically, it was estimated that for every MPS-PPV repeat unit there were 150 CTAB molecules, 75 Brij56 molecules, or 8 P123 polymer strands. (On average each MPS-PPV strand is ˜1000 repeat units.)

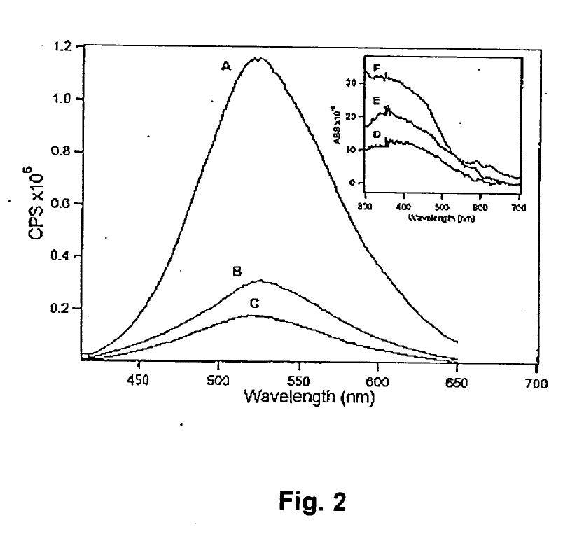

The choice of the surfactant species used to template the mesostructure does have a noticeable effect on the luminescence intensity from the nanocomposite films. As shown in FIG. 1, the emission intensity from a polymer-doped film templated by CTAB (FIG. 2, line A) is an order of magnitude greater than the emission observed from films templated by either P123 (FIG. 2, line B) or Brij56 (FIG. 2, line C). Further, slightly more polymer was incorporated into films using CTAB as a templating species than those using Brij56 as determined by UV-Vis absorption (see inset FIG. 2). Even less polymer was included into sol-gel films prepared from ethanolic silicate solutions containing MPS-PPV in the absence of any surfactant species (see inset FIG. 2, line D). Such polymer-doped sol-gel films exhibit no luminescence. While not wishing to be bound by the present explanation, the lack of luminescence is presumed due to self-quenching effects promoted by chain-to-chain interactions.

Reversible quenching of polymer emission in the solid state is, in general, difficult due to a strong interaction between polymer and quencher, although some notable exceptions are known (see Yang et al., J. Amer. Chem. Soc., v. 120, pp. 11864-11873 (1998) and Cumming et al. IEEE Trans. Geoscience and Remote Sensing, v. 39, 1119-1128 (2001)). Reversible quenching of MPS-PPV encapsulated in surfactant templated nanocomposite films has now been demonstrated. Emission from MPS-PPV-doped nanocomposite films was determined after exposure to a saturated atmosphere of 2,4-dinitrotoluene (DNT) for 24 hours as seen in FIG. 2 (dashed lines). Quenching of the MPS-PPV emission was observed to varying degrees in each nanocomposite film. The largest quenching effects were observed for CTAB nanocomposite films followed by Brij56 and lastly by P123 nanocomposite films (see Table 1). Exposure of the quenched films to vacuum for 24 hours almost completely removed DNT from the P123 and BrijS6 films, which recovered essentially all of the initial luminescence intensity, but not from the CTAB film, which regained only about 54% of the original emission intensity (see FIG. 2 and Table 1).

TABLE 1
Emission from MPS-PPV in an ethanolic solution or encapsulated in
nanocomposite films as a function of excitation wavelength.

| Ex(λ) | | Emission (λₘₐₓ (nm)) | | |
|---|---|---|---|---|
| (nm) | Solution | CTAB | Brij56 | P123 |
| 350 | 530 | 515 | 515 | 531 |
| 400 | 537 | 515 | 520 | 530 |
| 450 | 557 | 520 | 520 | 532 |
| 500 | 564 | 530 | 534 | 536 |

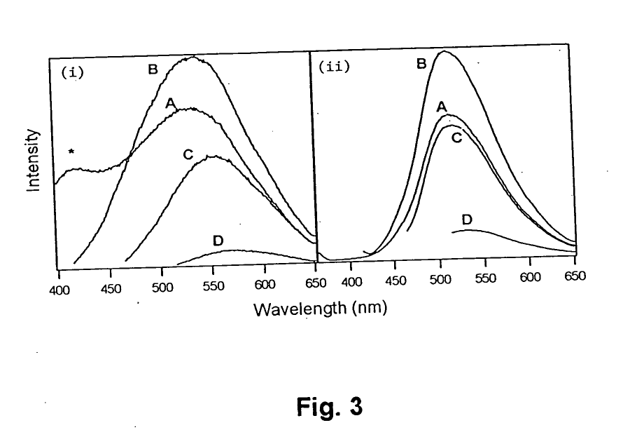

The choice of the surfactant species used to template the mesostructure also has a noticeable effect on the luminescent properties of the polymer, as well as the amount of polymer incorporated into a nanocomposite film. It is well known that emission from MPS-PPV in solution is dependent upon excitation wavelength. As shown in Table 1, FIG. 3(i) and FIG. 3(ii), excitation of MPS-PPV in ethanol at 400 nm results in emission at 537 nm while excitation at 450 nm yields emission at 557 nm. The emission dependence on excitation wavelength is attributed to a heterogeneous distribution of independent emitters, which results from numerous polymer chain conformations in solution. Upon encapsulation of MPS-PPV in a nanocomposite film, however, polymer emission is no longer dependent on excitation wavelength between 350-450 nm as seen in FIG. 3(ii) for a MPS-PPV-doped nanocomposite film templated by CTAB. Similar results are obtained from MPS-PPV doped nanocomposite films templated by Brij56 or Pluronics123 as seen in Table 1. Excitation between 350 and 450 nm results in an emission max close to 515 nm. However, 500 nm excitation causes a red-shift of the emission to 530 nm, but with a significant loss in overall emission intensity. This luminescence behavior is similar to that observed from aqueous solutions containing MPS-PPV and surfactant molecules. However, in solution the emission maxima are red-shifted to about 565 nm indicating that polymer chains immobilized in nanocomposite films are not as extended/conjugated. Luminescence from MPS-PPV-doped nanocomposite films templated by Brij56 or Pluronics123 is similarly independent of excitation wavelength.

Changing the surfactant species used to template the mesostructure also has an effect on the luminescence intensity from the nanocomposite films. As shown in FIG. 2, the emission intensity from a polymer-doped film templated by CTAB (FIG. 2, line A) is an order of magnitude greater that the emission observed from films templated by either Pluronics123 (FIG. 2, line B) or Brij56 (FIG. 2, line C). Further, slightly more polymer was incorporated into films using CTAB as a templating species than those using BriJ56 as determined by UV-Vis absorption (see inset FIG. 2, line D). Even less polymer is included into sol-gel films prepared from ethanolic silicate solutions containing MPS-PPV in the absence of any surfactant (FIG. 2, line D). Such polymer-doped sol-gel films exhibit little to no luminescence, presumably due to self-quenching effects promoted by chain-chain interactions. These data indicate that an association between polymer and surfactant exists, which promotes encapsulation into nanocomposite films. The additional polymer found in the CTAB-films can account for only a fraction of the intensity differences between films. Therefore, it is likely that the conformation of the polymer in the presence of the different surfactant species gives rise to the differences in emission intensity. The surfactant species-polymer interactions appear to inhibit polymer chain-chain interactions, which removes self-quenching processes.

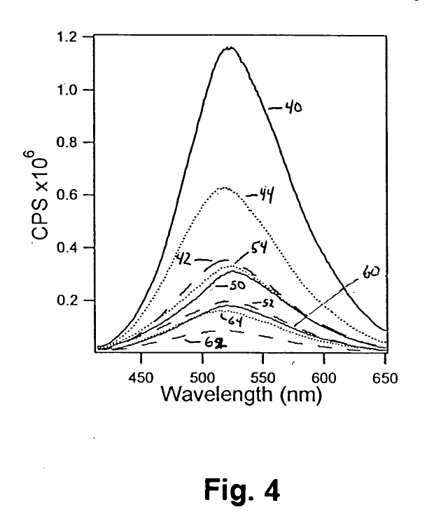

Although the polymer is encapsulated within the nanocomposite film, it is still accessible by vapor phase species. The emission from MPS-PPV-doped nanocomposite films was measured after exposure to a saturated atmosphere of DNT for eight hours (FIG. 4). In all three types of films quenching of the MPS-PPV emission was observed to varying degrees (FIG. 4 line 40 for CTAB, line 50 for P-123 and line 60 for Brij56 and Table 2). Emission from films templated by CTAB was quenched by 69% (line 42), while emission from films templated by Brij56 and Pluronics123 were only quenched by 53% and 37%, lines 62 and 52, respectively. These results show a correlation between the size of the surfactant and the sensing ability of a polymer-doped nanocomposite film. That is, it was observed that as the surfactant used to template the mesostructure gets larger the ability of DNT to quench polymer emission decreases. Charge appeared to be less of a factor in determining quenching behavior, as both Brij56 and Pluronics123 are non-ionic surfactants. The luminescence from each film was also recovered to varying degrees by exposing the quenched films to vacuum for twelve hours. Films templated by Pluronics123 regain 100% of their initial luminescence (line 54), while those films templated by B56 and CTAB recovery only 88% and 60% lines 64 and 44, respectively, as seen in Table 2. The Pluronics123 templated nanocomposite film was also repeatedly exposed to DNT and vacuum without any observable degradation to the film or its sensing ability. The same film with the Pluronics123 demonstrated a detectable response to DNT vapor upon exposure in as little as 15 minutes.

TABLE 2
Luminescence quenching and recovery of MPS-PPV-doped
nanocomposite films.

| Surfactant template | % quenched | % recovery |
|---|---|---|
| CTAB | 69 | 54 |
| P123 | 37 | 100 |
| Brij56 | 53 | 88 |

Based on this data, it appears that the larger surfactant microphases allow an interaction to occur between the polymer and nitroaromatic species that is sufficiently conditions (20 mTorr). The interaction between polymer and gas phase DNT is much stronger in films templated by Brij56 and CTAB as indicated by the greater extent of luminescence quenching and significantly reduced recovery. Thus, this data indicates that the polymer responsible for luminescence/sensing is largely located within the surfactant micelles and is better shielded by larger surfactant species.

In summary, it has been shown that the luminescence intensity and amount of polymer incorporated into nanocomposite films is dependent upon the surfactant used as the templating phase and therefore the luminescence properties can be tuned. It has been shown that gas phase nitroaromatic molecules could quench the luminescence of polymer from the vapor phase molecules, resulting in materials that could be repeatedly used for sensing measurements. A fully reversible sensor has been developed using the block-copolymer, Pluronics123 as the template for the nanocomposite film.

Although the present invention has been described with reference to specific details, it is not intended that such details should be regarded as limitations upon the scope of the invention, except as and to the extent that they are included in the accompanying claims.

1. A composite structure comprising:
an inorganic thin film having a defined mesostructure formed in a surfactant based formation process including a non-cationic surfactant template material; and,
a conjugated polymer immobilized within said mesostructured inorganic thin film.

2. The composite structure of claim 1 wherein said conjugated polymer is water-soluble.

3. The structure of claim 1 wherein said conjugated polymer is poly(2,5-methoxy-propyloxy sulfonate phenylene vinylene).

4. The structure of claim 1 wherein said surfactant based formation process includes a surfactant selected from the group of anionic surfactants and neutral surfactants.

5. The structure of claim 2 wherein said inorganic thin film is of silica.

6. A sensor comprising:
a responsive element for a detectable species, said responsive element including a nanocomposite structure of an inorganic thin film having a defined mesostructure and a conjugated polymer immobilized within said mesostructured inorganic thin film; and,
a detector means for detecting a response of said responsive element upon exposure to said detectable species.

7. The sensor of claim 6 wherein said mesostructure is defined during a surfactant based formation process.

8. The sensor of claim 6 wherein said conjugated polymer is poly(2,5-methoxy-propyloxy sulfonate phenylene vinylene).

9. The sensor of claim 6 wherein said surfactant based formation process includes a surfactant selected from the group of cationic surfactants, anionic surfactants and neutral surfactants.

10. The sensor of claim 6 wherein said responsive element is essentially fully reversible.

11. The sensor of claim 11 wherein said surfactant is a neutral block co-polymer.

12. The sensor of claim 6 wherein said inorganic thin film is of silica.

13. A method of detecting trace amounts of nitro-containing organic species within an environment comprising:
placing a selected chemical sensor into an environment, said sensor including a responsive element for said detectable nitro-containing organic species, said responsive element including a nanocomposite structure of an inorganic thin film having a defined mesostructure and a conjugated polymer immobilized within said mesostructured inorganic thin film, said sensor element adapted for a chemical interaction of a nitro-containing organic species therewith, for a sufficient time wherein nitro-containing organic species can have a chemical interaction with said responsive element;
measuring a change resulting from said chemical interaction of nitro-containing organic species with said responsive element; and,
correlating said measured change with a quantitative or qualitative output relating to said nitro-containing organic species.

14. The method of claim 13 wherein said conjugated polymer is poly(2,5-methoxy-propyloxy sulfonate phenylene vinylene).

15. The method of claim 13 wherein said surfactant based formation process includes a surfactant selected from the group of cationic surfactants, anionic surfactants and neutral surfactants.

16. The method of claim 13 wherein said responsive element is essentially fully reversible.

17. The method of claim 13 wherein said surfactant is a neutral block co-polymer.
